(19) United States
(12) Patent Application Publication
(10) Pub. No.: US 2006/0176685 A1
(43) Pub. Date: Aug. 10, 2006

(54) MINIATURE FLASHLIGHT

(76) Inventors: Robert D. Galli, North Kingstown, RI (US); David A. Glynn, Seekonk, MA (US)

Correspondence Address: BARLOW, JOSEPHS & HOLMES, LTD., 101 DYER STREET, 5TH FLOOR, PROVIDENCE, RI, 02903, US

(21) Appl. No.: 11/276,001

(22) Filed: Feb. 9, 2006

Related U.S. Application Data
(60) Provisional application No. 60/651,744, filed on Feb. 10, 2005.

(51) Int. Cl. F21L 4/00

(52) U.S. Cl. 362/157

(57) ABSTRACT

An improved miniature flashlight construction including a housing that is formed to include an upper shell and a lower shell. An interior module is positioned within the housing and includes a circuit board, control circuitry, a switch contact and a modular socket into which a light emitting diode (LED) is received. A flexible actuator element is formed within the upper shell of the housing disposed adjacent the switch contact on the interior module for engaging the switch contact when the actuator is depressed. By providing a socket for receiving the LED, the interior module can be formed as a single modular part for use in a miniature flashlight having any colored LED. Further, the interior module may include storage memory for storing operation instructions making the flashlight multifunctional.

### CROSS-REFERENCE TO RELATED APPLICATIONS

This application is related to and claims priority from earlier filed U.S. Provisional Patent Application No. 60/651,744, filed Feb. 10, 2005, the contents of which are incorporated herein by reference.

### BACKGROUND OF THE INVENTION

The present invention relates generally to a miniature light emitting diode flashlight assembly. More specifically, the present invention relates to high brightness, miniature light emitting diode flashlights, such as key lights or small personal flashlights that are tailored for high efficiency and high volume manufacturability and include modularized components.

The recent development of low cost, high brightness light emitting diodes, or LED's, has provided light manufacturers with a new alternative to conventional filament light bulbs as a light source in flashlights and other types of small personal lights. The advantages provided by such a change to LED's is evidenced in lower power consumption, longer lamp life, greater durability and increased resistance to shocks. As a result, there is always a need for newer constructions and arrangements that reduce the number of parts required in the assembly, simplify manufacturing procedures, and ultimately reduce the overall cost of the device. Further, in view if the availability of relatively inexpensive control circuitry, there is a desire for miniature flashlights of this type to include multi-functionality as is typically expected from an electronic product that is available on the consumer market today.

In this regard, there are a large number of miniature LED flashlights available on the market today. In general, all of these lights include the same basic components such as a housing, an LED light source, a compact power source such as a coin cell battery and a means for selectively energizing the LED by completing an electrical circuit between the LED and power source. The manner in which the housing is manufacture and the circuit is completed within the available flashlights is as varied as the number of flashlights that are available and range from overly complex to overly simplistic. In terms of complexity, some miniature flashlights employ multi-component housings that are extremely complex and include internal frames, external housing covers, external housing frames and push buttons that extend through the housing covers permitting activation of the light. Similarly, some of the more complex switching arrangements in the prior art include extensions that extend from the LED leads, contact plates such as dome switches, spacers, insulation components and push button actuators that engage the LED leads and/or the contact plates for switch activation. The difficulty with these flashlight assemblies is that they are overly complex requiring the manufacture of literally dozens of pieces that in turn have to be assembled into a finished flashlight. This level of complexity drives up the costs associated with both manufacturing and assembly while frequently producing a greater percentage of defective finished flashlights.

At the other end of the spectrum there are numerous simple flashlights assemblies that include a partially flexible case with an LED and a battery enclosed therein. The two leads of the LED straddle two opposite sides of a coin cell battery. Activation of the light is accomplished by squeezing the case, which in turn presses the leads of the LED into the battery, thereby energizing the LED. While this particular assembly includes a limited number of components thereby streamlining manufacturability and overall cost, flashlights in this category may frequently develop reliability problems and are generally produced using larger tolerances and lower quality control standards.

In addition to the above noted flashlight configurations, some miniature flashlights, in an attempt to compete in a higher tech marketplace have incorporated control circuitry into the device in the form of a small circuit board with a programmable chip thereon. The inclusion of such control circuitry as was stated above provides the manufacturer to provide a flashlight that has multi-functionality. In addition, frequently a switching mechanism is also mounted to the board and the leads of the LED are soldered directly onto the board during the circuit board manufacturing process. The fully assembled circuit board is then contained within a housing. The problem with this type of assembly is that often LED flashlights are produced in a variety of different colors including red, green, blue, white, etc. Therefore, a manufacture that utilizes a circuit board assembly in their flashlight must manufacture and maintain a separate inventory of circuit boards for each color that they manufacture. This not only drives up the manufacturing cost, it dramatically increases the amount of inventory that a manufacturer must maintain on hand for a smooth assembly process.

In view of the foregoing, there is a need for a miniature flashlight that provides an improved construction, which requires a reduced number of components thereby improving the overall product, reducing the need for large inventories of component parts and reducing the complexity of the assembly process. Further, there is a need for an inexpensive miniature flashlight that provides a balance between ruggedness, durability and complexity while also providing multi-functionality and a high quality appearance and feel.

### BRIEF SUMMARY OF THE INVENTION

In this regard, the present invention provides an improved miniature flashlight construction including a housing that is formed to include an upper shell and a lower shell. An interior module is positioned within the housing and includes a circuit board, control circuitry, a switch contact and a modular socket into which a light emitting diode (LED) is received, as will be discussed in detail below. A flexible actuator element is formed within the upper shell of the housing disposed adjacent the switch contact on the interior module for engaging the switch contact when the actuator is depressed.

As was stated above, the interior module includes a circuit board with control circuitry, a switch contact, a socket for receiving an LED and first and second battery contacts thereon. One of the notable features of the present invention is that by providing a socket for receiving the LED, the interior module can also be formed as a single modular part for use in a miniature flashlight having any colored LED. This is an important feature of the present invention because in the prior art, since the LED was soldered to the circuit board, a circuit board assembly had to be made for each color of light manufactured. In the present invention, the interior module can be made the same regardless of the LED color thereby allowing the desired color of LED to be plugged in at the time of assembly.

In addition, in one preferred embodiment of the present invention, the switch contact on the interior module is used to provide instructions to the control circuitry, thereby providing the miniature flashlight with multi-functionality. For example, if the dome is pressed and held more than 1 second, the light operates in momentary mode as provided above. Similarly, if the switch is pressed once and released in less than a second, the LED is energized in a constant “on” function. Further, other control schemes and arrangements may be provided.

Accordingly, among the objects of the present instant invention are: the provision of small, lightweight, low cost flashlight having a superior brightness level, and extended longevity; the provision of a miniature flashlight construction that utilizes a high brightness LED as a light source; the provision of a miniature flashlight that uses a resilient housing portion as part of the switch arrangement; the provision of a miniature flashlight having a reduced number of parts; the provision of a miniature flashlight that includes multifunctional capabilities and the provision of a miniature flashlight that can be easily disassembled to replace spent batteries.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a front perspective view of one embodiment of a fully assembled miniature flashlight as disclosed in the present invention;

FIG. 2 is a front, exploded perspective view of a the miniature flashlight of FIG. 1;

FIG. 3 is an exploded perspective view of an interior module of the miniature flashlight of the present invention;

FIG. 4 is a cross sectional view of the interior module taken along line 4-4 of FIG. 2;

FIG. 5 is a bottom perspective vies of the miniature flashlight with the lower shell of the housing removed; and

FIG. 6 is a cross sectional view of the flashlight of the present invention taken along line 6-6 of FIG. 1.

### DETAILED DESCRIPTION OF THE INVENTION

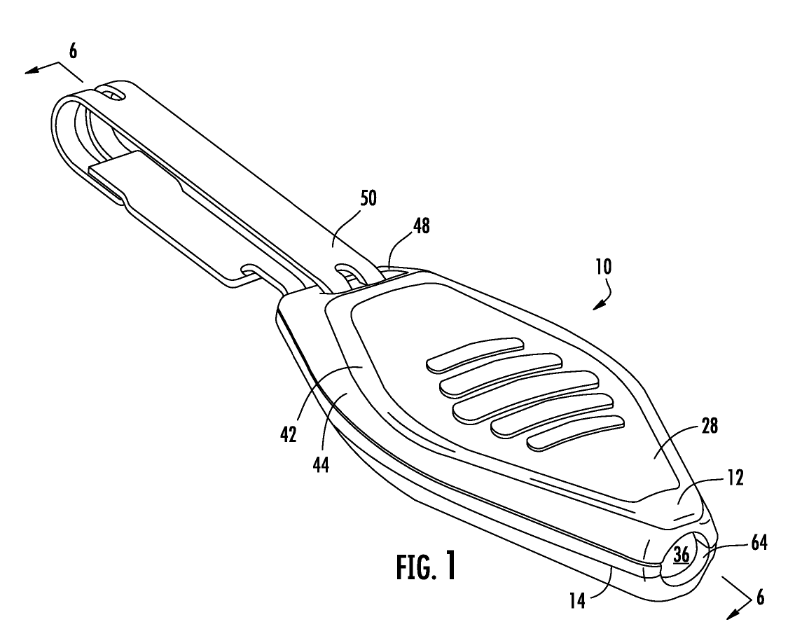

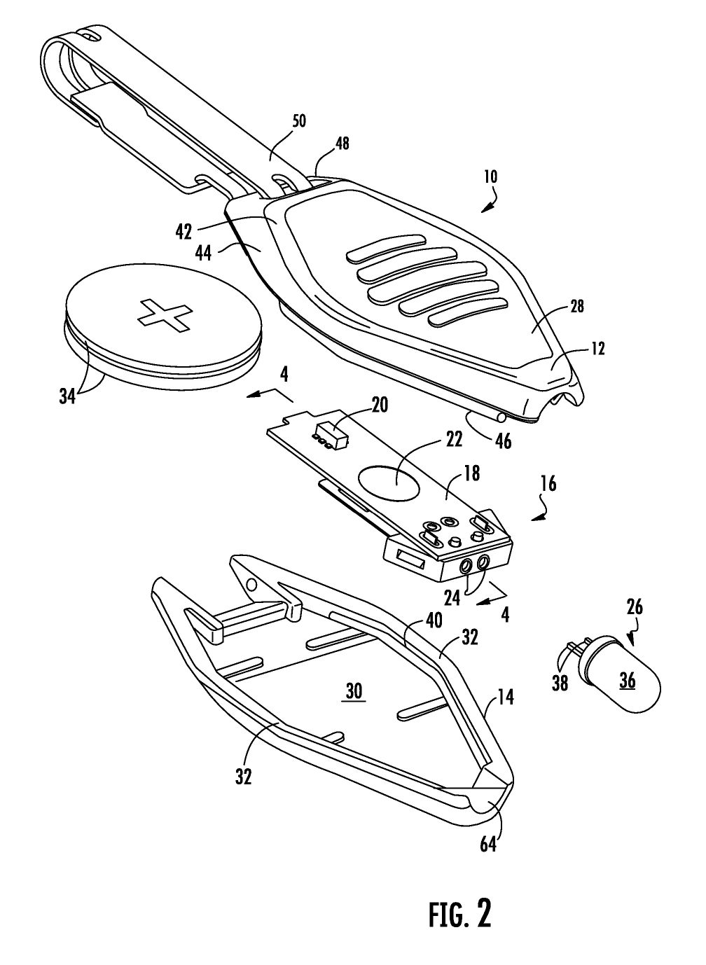

Now referring to the drawings, the miniature flashlight of the present invention is shown and generally illustrated at 10 in the figures. Turning to FIGS. 1 and 2, it can be seen that the present invention provides an improved miniature flashlight 10 construction including a housing that is formed to include an upper shell 12 and a lower shell 14 wherein the upper and lower shells 12, 14 are configured to matingly interfit with one another to form a complete housing. An interior module 16 is positioned in a cavity within the housing and includes a circuit board 18, control circuitry 20, a switch contact 22 and a pair of modular lead sockets 24 into which a light emitting diode 26(LED) is received. A flexible actuator 28 element is formed within the upper shell 12 of the housing disposed adjacent the switch contact 22 for engaging and displacing the switch contact 22. The lower shell 14 of the housing includes a bottom wall 30 and a continuous side wall 32 extending upwardly from the bottom wall 30, wherein the bottom wall 30 and side wall 32 cooperate to form an upwardly opening interior cavity for receiving and positioning the interior module 16, the LED 26 and batteries 34 therein. The LED 26 has a head portion 36 and two spaced contact leads 38 extending rearwardly from the head portion 36. As will be discussed in detail below, the leads 38 of the LED 26 are received into and retained in the lead sockets 24 on the interior module 16.

The preferred light source of the miniature flashlight 10 of the present invention is as stated above, an LED 26. The LED 26 may be any type LED 26 that is suitable for flashlight use. In most cases the LED 26 will be a high brightness LED. Further, the LED 26 may be any available color of LED including but not limited to visible colors such as red, blue green and white. Additionally, the LED 26 may produce a light output beyond the visible range such as in the ultra-violet or infrared ranges.

As was stated above, the upper shell 12 and lower shell 14 are configured to matingly interfit to form a housing. As is shown in the figures, the lower shell 14 includes a bottom wall 30 with a peripheral sidewall 32 extending upwardly therefrom. The interior surface of the sidewall 32 is formed to include a channel 40 therein. Similarly, the upper shell 12 includes a top wall 42 with a sidewall 44 extending downwardly therefrom wherein the sidewall 44 terminates in a ridge 46 that is configured to be received into and engage the channel 40 within the side wall 32 of the lower shell 14 when the upper and lower shell components 12, 14 are brought together in assembled relation. It should also be appreciated by one skilled in the art that the positioning of the channel 40 and the ridge 46 can be reversed relative to their positioning on the upper and lower shells 12, 14 and relative to one another (interior versus exterior) and still remain within the present disclosure. This particular configuration allows the upper shell and lower shell 12, 14 to be releasably secured in a reliable fashion while also allowing the upper shell and lower shell 12, 14 to be separated should the batteries 34 need to be replaced by the user.

In addition, one of the upper or lower shells 12, 14 can be formed to include an extension 48 that serves as a point of attachment for receiving a key ring hook 50. The key ring hook 50 is a spring clip that passes through the aperture and around the extension 48 provided in the shell and allows the miniature flashlight 10 to be attached to various objects such as a user's clothing, key ring or the like. It can also be seen that the extension 48 point of attachment is provided on only one of the two shell portions 12, 14, thereby allowing the two shells 12, 14 of the flashlight 10 to be separated without requiring that the key ring hook 50 be first removed.

The upper shell and lower shell members 12, 14 are formed preferably in an injection molding process using any suitable polymer material. While any polymer material may be used that exhibits sufficient tensile strength and flexural modulus properties, as can be determined by anyone skilled in the art, the upper shell and lower shell 12, 14 are preferably formed from a polycarbonate or ABS material. Further, the upper shell 12 and lower shell 14 may be formed without the addition of any pigmenting additive, thereby creating translucent shell members 12, 14, with a translucent dye added, thereby forming colored translucent shell members 12, 14 or with a solid pigmenting additive, thereby forming opaque shell members 12, 14. Similarly, any combination of the above may be used to form, each of the lower and upper shells 12, 14 separately. The upper shell 12 can also be seen to include a central region that appears to be formed form a different material. The central region in the upper shell 12 is formed to receive an actuator 28. In the simplest form, the actuator 28 may be a push button that simply extends through an aperture 52 provided in the top wall 42 of the upper shell 12. In this manner, the actuator 28 is positioned to selectively engage and operate the flashlight 10 as will be discussed in further detail below. Alternately, in the preferred embodiment, the actuator 28 is formed as an integral part of the upper shell 12 using either a multi-shot or insert injection molding process. In this manner, an aperture 52 is provided in the top wall 42 of the upper shell 12 during the manufacturing process. A flexible material is molded over at least a portion of the outer surface of the upper shell portion 12 covering the aperture 52 therein. The flexible material is preferably a polymer and may be a flexible natural rubber, a flexible polymer, a thin layer of deformable polycarbonate or an elastomer. To operate the miniature flashlight 10 the user presses upon the flexible material actuator 28 thereby deforming the actuator 28 through the aperture 52 in the upper shell 12 and depressing the switch contact 22 on the circuit board 18. If the insert molding technique is being used, the molded upper shell 12 is placed into a mold cavity and the actuator member 28 is molded onto the upper shell 12 to fill the at least a portion of the aperture 52 in the top wall 44 of the upper shell 12 to provide an actuator member 28. Should the multi-shot molding process be used, a portion of the mold cavity that is utilized in molding the upper shell 12 is removed and a second mold cavity is brought into position adjacent the top wall 44 of the upper shell 12 thereby allowing a second material to be injected thereby filling at least a portion of the aperture 52 in the upper shell 12 to form an actuator 28. The actuator 28 is preferably formed from a flexible polymer material or an elastomeric polymer. Further, the material that is used for the actuator 28 may be pigmented using a color that matches the color output of the LED using colors such as red, green, blue and white. Further, the actuator 28 may be gray or any other color that is feasible.

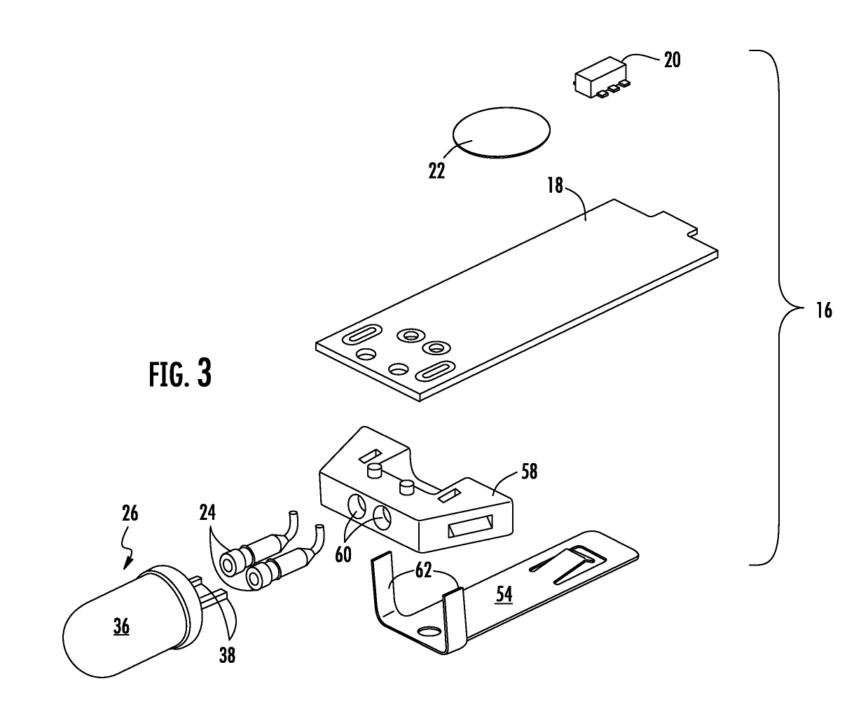

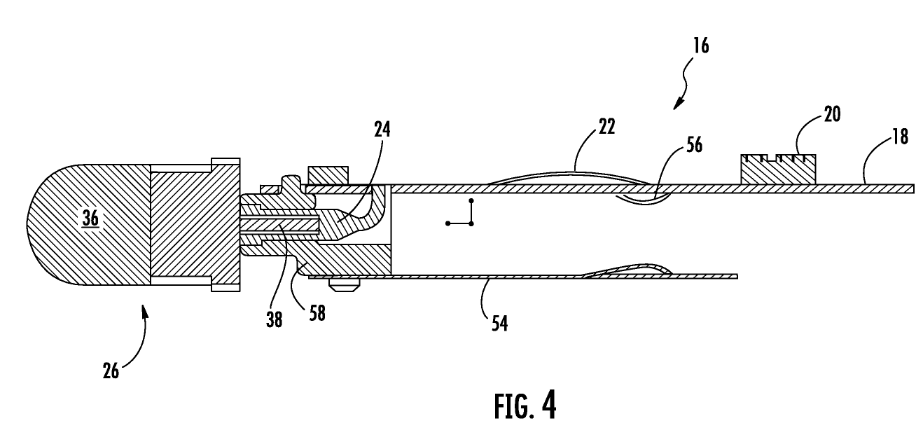

Turning now to FIGS. 3 and 4, details of the construction of the interior module 16 are shown. As was stated above the interior module 16 includes at a minimum, a pair of lead sockets 24, a circuit board 18 with a switch contact 22 disposed thereon and first and second battery contacts 54, 56. In addition, the interior module 16 may be formed to include control circuitry 20 and a socket support 58. As can be seen in the figures, the socket support 58 is formed to include channels 60 that are configured to hold and support the at least two lead sockets 24 that are in turn configured to receive and retain the shortened leads 38 of the LED 26. The sockets 24 extend into the socket support 58 and are in electrical communication with the circuit board 18. By providing sockets 24 for receiving the LED 26, the interior module 16 can also be formed as a single modular part for use in a miniature flashlight 10 having any colored LED 26. In the prior art, since the LED 26 was soldered to the circuit board, a circuit board assembly had to be made for each color of light manufactured. In the present invention, the interior module 16 can be made the same regardless of the LED 26 color and the desired color of LED 26 can be plugged into the lead sockets 24 at the time of assembly.

The interior module 16 further includes a second battery contact 54 that is positioned in spaced relation to the circuit board 18 such that a power source 34 like at least one coin cell battery can be received and retained between the circuit board 18 and the second battery contact 54. The second battery contact 54 includes arms 62 that extend through the socket support 58 and into the circuit board 18 where they are in electrical communication with and soldered to the circuit board 18. In this manner, the second battery contact 54 serves to hold the socket support 58 and the circuit board 18 in a single integrated module for installation into the upper shell 12 of the housing. Once the interior module 16 is fully assembled it can be appreciated that the leads 38 of the LED 26 are in electrical communication with the switch contact 22, the battery contacts 54, 56 and ultimately with the power source 34 in a manner that allows a circuit including the LED 26, the power source 34 and the switch contact 22 to be completed when the switch contact 22 is depressed, thereby energizing the flashlight 10.

The power source 34 for the present invention is any suitable type of battery of portable power source utilized in flashlights. More preferably, the power source 34 is a coin cell battery wherein each of the sides of the battery serves as a contact surface.

As was stated above, the circuit board 18 also may include control circuitry 20 and a switch contact 22 thereon. The switch contact 22 may be any suitable contact known in the flashlight art. Preferably, the switch contact 22 is a dome type switch that serves to make momentary contact thereby energizing the flashlight 10 while the contact is depressed. However, the switch contact 22 may be a hinged contact, a lever contact, a blade contact. A spring contact or any other switching arrangement known in the art. Further, in the preferred embodiment, the switch contact 22 may be used to provide instructions to the control circuitry 20 thereby providing the miniature flashlight 10 with multi-functionality. For example, if the switch contact 22 is pressed and held more than 1 second, the light 10 operates in momentary mode as provided above. If the switch contact 22 is pressed once and released in less than a second, the LED 26 is energized in a constant “on” function. Alternately, the flashlight 10 may operate in a manner that sequentially steps through each of the available sets of instructions within the control circuitry 20 in order, but includes a delay before energizing the LED 26 in that mode while waiting to see if the user intends to press the switch contact 22 again to advance to the next set of instructions. In this manner, the flashlight 10 has the appearance that pressing the actuator 28 several times in succession causes the flashlight 10 to “jump” directly to the desired mode, when in reality the flashlight 10 is simply stepping through each of the modes. This provides the appearance of a very high-end control scheme while using code in a very efficient manner. Further, other control schemes and arrangements may be provided and may include various modes such as low intensity, high intensity, strobe, SOS and demonstration mode for example.

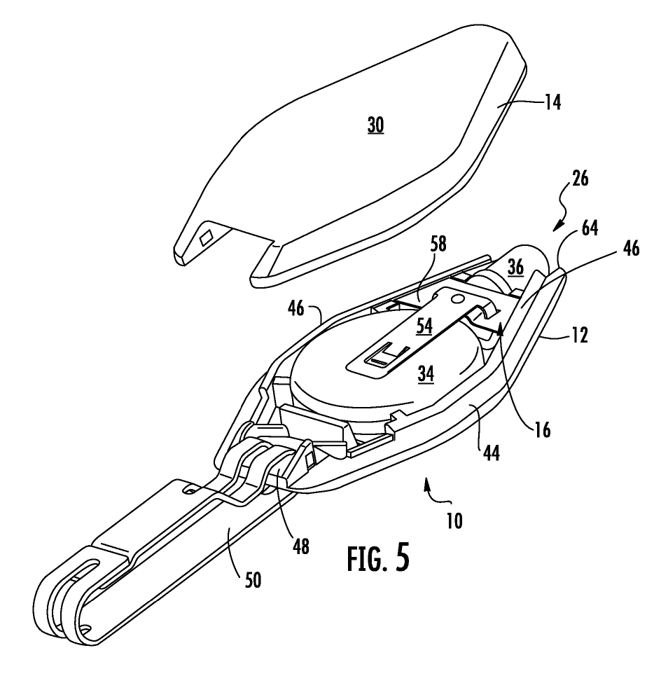

Turning now to FIG. 5, it can be seen that the interior module 16 with the LED 26 installed therein is placed into the upper shell 12. A seat is provided to receive and support both the interior module 16 and the LED 26. Further, the socket support 58 may include formations that are engaged by structure extending from the sidewalls of the upper shell 12 to retain and support the socket support 58 and therefore the entire interior module 16 within the upper shell 12. The lower shell 14 is then positioned adjacent the upper shell 12 and snapped into mated relation therewith to complete the flashlight 10 assembly. Any known mating formations may be utilized to retain the upper and lower shells 12, 14 in mated relation. In this case, the lower shell 14 has a groove 40 around the interior periphery thereof and the upper shell 12 includes a detent 46 that engages the groove 40. Similarly, other useful mating formations such as pins or snap hooks may be employed in addition to or in conjunction with the previously described channel and ridge arrangement.

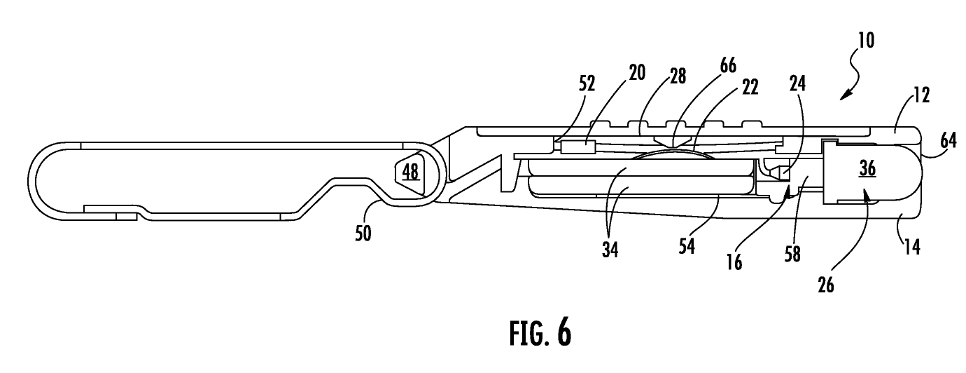

FIG. 6 depicts a cross-sectional view of the miniature flashlight 10 as fully assembled. Clearly, the interior module 16 can be see in its received position within the cavity formed by the upper and lower shell members 12, 14. Additionally, the head portion 36 of the LED 26 can be seen captured in a channel 64 that extends between the upper and lower shell members 12, 14 from the interior cavity to the exterior of the miniature flashlight 10. In this manner, the light output from the LED 26 is directed to the exterior of the flashlight 10. Further, the actuator 28 can be seen to include a small detent 66 on its lower surface, in a position that corresponds to the location of the switch contact 22 on the interior of the flashlight 10. This detent 66 is provided to insure positive contact between the actuator 28 and the switch contact 22.

It can therefore be seen that the present invention provides a small, lightweight, low cost LED flashlight that includes both a high performance LED light source and is enabled in a manner that provides multi-functionality. Further, the present invention provides a miniature flashlight assembly that is modularized and requires a greatly reduced number of parts in a manner that simplifies its manufacture and assembly to create a useful and novel flashlight. For these reasons, the instant invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A flashlight assembly comprising:
a first housing shell;
a second housing shell, said first and second housing shells including complementary mating formations to retain said first and second housing shells in mated relation, said first and second housing shells cooperating to form an interior cavity;
a light emitting diode having a head portion and first and second contact leads extending rearwardly from said head portion, said head potion being received in a channel extending from said interior cavity to an exterior of the flashlight;
an interior module including:
a circuit board,
first and second lead sockets positioned at one end of said circuit board, said first and second leads of said light emitting diode being received and retained in said first and second lead sockets,
first and second battery contacts,
a power source having first and second contact surfaces, said first and second contact surfaces in electrical communication with said first and second battery contacts on said interior module, and
a switch contact disposed on a surface of said circuit board in electrical communication with said first and second battery contacts and said first and second lead sockets, said interior module received in said interior cavity; and an actuator disposed within said first housing shell adjacent said switch contact, said actuator being selectively depressible to engage and depress said switch contact thereby energizing a circuit including said light emitting diode, said power source and said switch contact.

2. The flashlight assembly of claim 1, wherein said first housing shell further comprises:
a first housing shell having a top surface and a bottom surface and an aperture extending between said top surface and said bottom surface; and
said actuator member being a flexible member received onto said top surface of said first housing shell, said flexible member disposed over said aperture.

3. The flashlight assembly of claim 2, wherein said actuator member is an elastomeric layer that is molded onto said top surface of said first housing member.

4. The flashlight assembly of claim 3, wherein said actuator member is molded onto said top surface of said first housing member using a process selected from the group consisting of: insert molding and multi-shot injection molding.

5. The flashlight assembly of claim 4, wherein said light emitting diode has an output color selected from the group consisting of: red, green, blue and white.

6. The flashlight assembly of claim 5, wherein the color of said actuator matches the output color of said light emitting diode.

7. The flashlight assembly of claim 1, said interior module further comprising:
a socket support affixed to said one end of said circuit board, said socket support having two channels therein, said channels receiving and retaining said lead sockets.

8. The flashlight assembly of claim 1 said interior module further comprising;
control circuitry disposed on said circuit board, said control circuitry being in electrical communication with said power first and second battery contacts, said power source, said lead sockets and switch contact, said control circuitry configured to receive an input from said switch contact and energize the light emitting diode using one of at least two stored sets of instructions corresponding to said input.

9. The flashlight of claim 8 wherein said stored sets of instructions include instructions selected from the group consisting of: low intensity, high intensity, strobe, SOS and demonstration mode.

10. The flashlight assembly of claim 8, wherein said control circuitry monitors said switch contact to receive an input in the form of a timed sequence of switch contact depressions.

11. The flashlight assembly of claim 1, one of said first and second housing shells including an aperture for receiving a key ring clip.

12. The flashlight assembly of claim 11, wherein said first and second housing shells can be separated without removing said key ring clip.

13. The flashlight assembly of claim 1, wherein said first and second housing shells are formed from a translucent material.

14. The flashlight assembly of claim 1, wherein said light emitting diode has an output color selected from the group consisting of: red, green, blue and white.

15. The flashlight assembly of claim 14, wherein the color of said actuator matches the output color of said light emitting diode.

16. A flashlight assembly comprising:
a first housing shell;
a second housing shell, said first and second housing shells including complementary mating formations to retain said first and second housing shells in mated relation, said first and second housing shells cooperating to form an interior cavity;
a light emitting diode having a head portion and first and second contact leads extending rearwardly from said head portion, said head potion being received in a channel extending from said interior cavity to an exterior of the flashlight;
an interior module including:
a circuit board,
first and second lead sockets positioned at one end of said circuit board, said first and second leads of said light emitting diode being received and retained in said first and second lead sockets,
first and second battery contacts, said first battery contact in electrical communication with said first lead socket,
a power source having first and second contact surfaces, said first and second contact surfaces in electrical communication with said first and second battery contacts on said interior module, and
a switch contact disposed on a surface of said circuit board in electrical communication with said second battery contact and said second lead sockets, said interior module received in said interior cavity; and
an actuator disposed within said first housing shell adjacent said switch contact, said actuator being selectively depressible to engage and depress said switch contact thereby energizing a circuit including said light emitting diode, said power source and said switch contact.

17. A module for use in a miniature flashlight, said module comprising:
a circuit board;
first and second lead sockets positioned at one end of said circuit board;
a light emitting diode having a head portion and first and second contact leads extending rearwardly from said head portion, said first and second leads being received and retained in said first and second lead sockets;
first and second battery contacts;
a power source having first and second contact surfaces, said first and second contact surfaces in electrical communication with said first and second battery contacts; and
a switch contact disposed on a surface of said circuit board in electrical communication with said first and second battery contacts and said first and second lead sockets, said switch contact being selectively depressible thereby energizing a circuit including said light emitting diode, said power source and said switch contact.

18. The module of claim 17, further comprising:
a socket support affixed to said one end of said circuit board, said socket support having two channels therein, said channels receiving and retaining said lead sockets.

19. The module of claim 17, further comprising:
control circuitry disposed on said circuit board, said control circuitry being in electrical communication with said power first and second battery contacts, said power source, said lead sockets and switch contact, said control circuitry configured to receive an input from said switch contact and energize the light emitting diode using one of at least two stored sets of instructions corresponding to said input.

20. The module of claim 19, wherein said stored sets of instructions include instructions selected from the group consisting of: low intensity, high intensity, strobe, SOS and demonstration mode.

21. The module of claim 19, wherein said control circuitry monitors said switch contact to receive an input in the form of a timed sequence of switch contact depressions.

22. A housing assembly for a miniature flashlight comprising:
a first housing shell having a top surface and a bottom surface and an aperture extending between said top surface and said bottom surface;
a flexible member received onto said top surface of said first housing shell, said flexible member disposed over said aperture.
a second housing shell, said first and second housing shells including complementary mating formations to retain said first and second housing shells in mated relation, said first and second housing shells cooperating to form an interior cavity.

23. The housing assembly of claim 22, wherein said flexible member is an elastomeric layer that is molded onto said top surface of said first housing member.

24. The housing assembly of claim 23, wherein said flexible member is molded onto said top surface of said first housing member using a process selected from the group consisting of: insert molding and multi-shot injection molding.

25. The housing assembly of claim 22, one of said first and second housing shells including an aperture for receiving a key ring clip.

26. The housing assembly of claim 25, wherein said first and second housing shells can be separated without removing said key ring clip.

27. The housing assembly of claim 22, wherein said first and second housing shells are formed from a translucent material.

28. The housing assembly of claim 27, wherein said actuator member has a color selected from the group consisting of: red, green, blue, gray and white.

29. The housing assembly of claim 22, wherein said actuator member has a color selected from the group consisting of: red, green, blue, gray and white.
